(19) United States
(12) Patent Application Publication
(10) Pub. No.: US 2026/0180900 A1
(43) Pub. Date: Jun. 25, 2026

(54) FORWARDING EQUIVALENCE CLASS RECOVERY AND RECONCILIATION

(71) Applicant: Arista Networks, Inc., Santa Clara, CA (US)

(72) Inventors: Hsiang Wen Cheng, Burnaby (CA); Tim Tang, Burnaby (CA); Arseniy Kouzmenkov, New Westminster (CA); Trevor Allen William Siemens, Coquitlam (CA)

(21) Appl. No.: 18/989,429

(22) Filed: Dec. 20, 2024

(51) Int. Cl. H04L 45/50; H04L 45/28

(52) U.S. Cl. CPC H04L 45/50; H04L 45/28

(57) ABSTRACT

A technique of restoring data in a network device includes, after a restart of an agent in the network device, obtaining, by the agent, a current fingerprint of a FEC (forwarding equivalence class) value stored in a persisted information base. The technique further includes retrieving, by the agent, a FEC identifier from a pre-restart persisted table based on the current fingerprint, the pre-restart persisted table associating multiple fingerprints of FEC values with respective FEC identifiers used by the agent prior to the restart, and updating a dataset of the agent to associate the retrieved FEC identifier with the FEC value.

### BACKGROUND

Network devices are common equipment used for directing packets along paths between endpoints of computer networks. Examples of network devices are switches and routers. A typical network device includes multiple ports, a CPU (central processing unit), memory for storing data and programs, and a hardware component, such as an ASIC (application-specific integrated circuit), for forwarding packets.

The memory of the network device persistently stores various data sources that specify rules for forwarding packets. Such data sources may include, for example, a FIB (forwarding information base) and an LFIB (label forwarding information base). The FIB defines forwarding instructions for incoming packets based on destination IP (Internet Protocol) prefixes, and the LFIB defines forwarding instructions for incoming packets based on labels, i.e., labels used in MPLS (multiprotocol label switching). The programs running in the network device provide an interface for control and management, allowing for changes in the data sources as well as changes in other features of the device. The programs typically encode the contents of the data sources in the ASIC, which uses these encodings to perform real-time forwarding of packets between ports.

The programs running in the network device include an agent. The agent may perform various functions, such as executing routing algorithms, calculating best paths, and/or preparing data for writing to the ASIC. For communicating with other components of the device, the agent maintains a dataset that provides the agent's view of the device's forwarding information. The dataset typically includes both IP-based routing information and label-based forwarding information. The label-based forwarding information associates identifiers (labels) of FECs (forwarding equivalence classes) with FEC values, which specify rules for next hops, e.g., other FEC identifiers, network identifiers, IP addresses, MAC (media access control) addresses, and the like. FEC values may be voluminous, and FECs may be arranged hierarchically, such that a packet may traverse multiple FECs enroute from an ingress port to an egress port of the network device.

From time to time, the agent may restart, e.g., to receive updates, to recover from faults, as part of a switchover between processors of the network device, or as part of a reboot of the network device. In response to a restart, the agent starts up and attempts to reconstruct its dataset, some of which may have been erased during the restart. To this end, the agent makes function calls to one or more other software components. Such function calls enable the agent to reconcile its dataset with hardware and with data in other software components, which persisted through the restart. Once the agent has rebuilt its dataset, the agent can resume its operations.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example network device in which embodiments of the improved technique can be practiced.

FIG. 2 is a block diagram of an example arrangement for rebuilding a dataset of an agent following a restart of the agent, according to one or more embodiments.

FIG. 3 is a flowchart of an example method of rebuilding a dataset of an agent following a restart of the agent, according to one or more embodiments.

FIG. 4A is a table showing example information stored in a persisted information base, according to one or more embodiments.

FIG. 4B is a graph of an example forest, which provides a graphical representation of the information stored in the table of FIG. 4A, according to one or more embodiments.

FIG. 5A is a table showing example information stored in the dataset of the agent prior to restart, according to one or more embodiments.

FIG. 5B is a graph of a pre-restart forest, which provides a graphical representation of the information stored in the dataset of FIG. 5A, according to one or more embodiments.

FIG. 6 is a diagram of an example pre-restart persisted table, according to one or more embodiments.

FIG. 7 is a table showing an example FEC relation store, according to one or more embodiments.

FIG. 8 is a table showing example information stored in the dataset of the agent after the restart and during a recovery process, according to one or more embodiments.

FIG. 9 is a table showing an example reverse map, according to one or more embodiments.

FIG. 10A is a graph showing an example post-restart forest during a recovery process, according to one or more embodiments.

FIG. 10B is a flowchart showing an example method of resolving duplicate fingerprints during the recovery process, according to one or more embodiments.

FIG. 11A is a graph showing another example post-restart forest during a recovery process, according to one or more embodiments.

FIG. 11B is a flowchart showing another example method of resolving duplicate fingerprints during the recovery process, according to one or more embodiments.

FIG. 12 is a flowchart showing an example method that may be carried out in connection with the network device of FIG. 1.

### DETAILED DESCRIPTION

The above-described solution for rebuilding an agent's dataset following a restart is not practical in all cases. Software architectures for network devices have evolved, and now an agent may not always have the ability to make function calls to other software components. For example, different software components may run in separate processes, which do not support function calls between them. What is needed, therefore, is a more independent way for an agent to recover its dataset following a restart, which does not rely on communications with other components running in other processes.

The above need is addressed at least in part by an improved technique of restoring data in a network device. In accordance with this technique, an agent runs in the network device and, prior to a restart of the agent, the agent persistently stores a table of FEC (forwarding equivalence class) identifiers used by the agent and fingerprints of associated FEC values. After the restart, the agent starts up and begins rebuilding the FEC information in its dataset. To this end, the agent obtains FEC values from a persisted information base (PIB), such as the FIB, LFIB, or some other source, which persisted through the restart. The agent assigns FEC identifiers from the persisted table to the FEC values obtained from the PIB by matching fingerprints calculated from the FEC values with fingerprints stored in the table. The agent then updates its dataset with the assigned FEC identifiers and the obtained FEC values. Advantageously, the improved technique enables recovery of the agent's dataset without having to communicate with other software components running in other processes.

To elaborate on the above and in accordance with one or more embodiments, the agent prior to restart maintains a dataset that includes both routing information and FEC information. Although the agent may persist the routing information, the agent typically stores the FEC information in volatile memory such that the agent's FEC information is lost when the agent restarts.

To enable recovery of the agent's FEC information after the restart, the agent persistently stores a pre-restart persisted table that associates multiple fingerprints of FEC values with respective FEC identifiers currently used by the agent. The fingerprints are short values, such as hash values, which can be used for distinguishing between different FEC values without having to compare the FEC values directly. The FEC identifiers (labels) are those used by the agent itself and generally differ from FEC identifiers used in other parts of the network device, such as in the PIB (e.g., FIB and LFIB). As changes are made in the PIB, the agent updates the pre-restart persisted table so that the pre-restart persisted table and the PIB remain in sync. The pre-restart persisted table thus provides a shortened version of the FEC information in the agent's dataset, as it replaces potentially voluminous FEC values with generally much shorter fingerprints. The pre-restart persisted table can be stored persistently without consuming nearly as much space as would be needed for storing the full FEC values.

After a restart occurs, the agent begins rebuilding its dataset. The routing information can be restored directly from persistent memory, but the FEC information cannot. To recover the FEC information, the agent obtains FEC values from the PIB and calculates or otherwise obtains fingerprints of those FEC values, i.e., using the same formula that was used to calculate the fingerprints stored in the pre-restart persisted table. The agent then attempts to pair the obtained FEC values with the FEC identifiers in the pre-restart persisted table by matching fingerprints. If the fingerprints are sufficiently strong, a match between fingerprints conclusively confirms a match between FEC values. The FEC identifiers associated with the matching fingerprints are then paired with the FEC values in the PIB, and the paired FEC identifiers and FEC values are written to the dataset, thus recovering the dataset. The agent can then resume its operations using the recovered dataset.

According to one or more embodiments, further activities may be performed to resolve duplicate fingerprints (“duplicates”), which may arise, for example, based on improper matches (hash collisions) as well as instances where the same FEC values are correctly associated with different FEC identifiers. These activities include persisting and maintaining a FEC relation store prior to restart. The FEC relation store captures parent-child relationships among different FEC identifiers used by the agent prior to restart. Such parent-child relationships enable the agent to resolve most duplicates, e.g., by identifying the parent of a particular FEC subject to a duplicate fingerprint, identifying a list of all child FECs of that parent, and then comparing the list of child FECs with a list of all FECs that share the duplicate fingerprint. Typically, only a single FEC appears on both lists, and the identifier of that FEC is assigned to the particular FEC which was subject to the duplicate fingerprint.

The ability to restore the same FEC identifiers after a restart that the agent used prior to the restart avoids negative downstream effects. For example, one or more other agents may rely on the dataset remaining the same after restart as before, as any changes in the dataset may cause routing errors and may necessitate remapping in the downstream agents and/or in the ASIC. The improved technique reduces or eliminates such errors and wasteful activities.

Embodiments of the improved technique will now be described. One should appreciate that such embodiments are provided by way of example to illustrate certain features and principles but are not intended to be limiting.

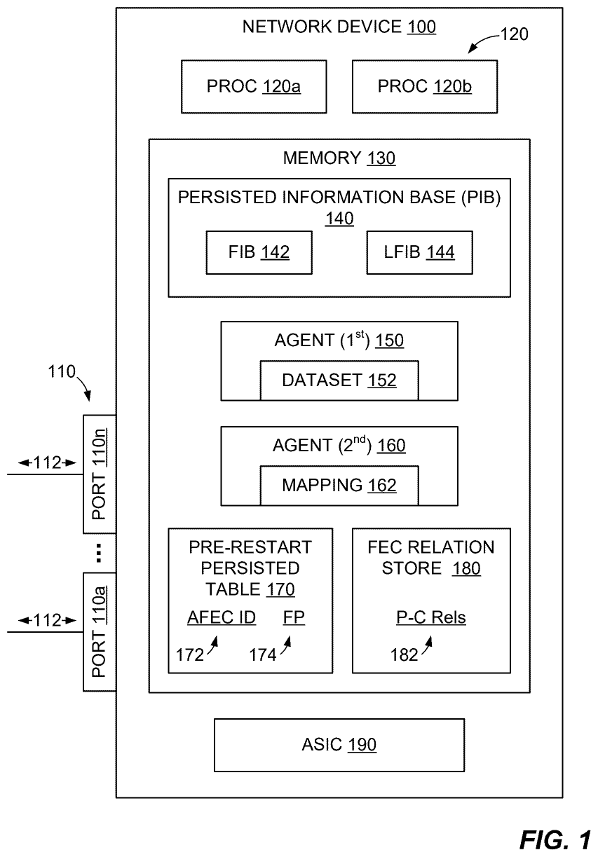

FIG. 1 shows an example network device 100 in which embodiments of the improved technique can be practiced. The network device 100 includes multiple network ports 110, a set of processors 120, memory 130, and an ASIC 190, which is configured to perform real-time packet processing. The network device 100 may be realized as a router or a switch, for example.

The ports 110 (e.g. 110a through 110n) include physical ports configured to connect with network cables for sending and receiving packets 112 to and from other network devices (not shown). The ports 110 may further include wireless ports configured to send and receive packets 112 wirelessly, e.g., using Wi-Fi, Bluetooth, or other wireless protocols.

The set of processors 120 typically includes two processors 120a and 120b, which may be realized as respective CPUs (central processing units). Other types of processors and/or coprocessors may be used, however.

The memory 130 includes both volatile memory, e.g., RAM (Random Access Memory), and non-volatile memory, such as one or more ROMs (Read-Only Memories), disk drives, solid state drives, and the like. The set of processors 120 and the memory 130 together form control circuitry, which is constructed and arranged to carry out various methods and functions as described herein. Also, the memory 130 includes a variety of software constructs realized in the form of executable instructions. When the executable instructions run on one or more of the processors 120, the processor(s) 120 carry out the operations of the software constructs. Although certain software constructs are specifically shown and described, one should appreciate that the memory 130 typically includes many other software components, which are not shown, such as an operating system, various applications, processes, and daemons.

In one example arrangement, one of the processors 120, such as 120a, is configured to control the network device 100 at a time, with the other processor, such as 120b, remaining available as a hot standby. For example, when the processor 120a fails or otherwise stops working, the processor 120b seamlessly takes over, such that operation of the network device 100 continues under control of the processor 120b with little or no disruption to packet forwarding.

As further shown in FIG. 1, the memory 130 “includes,” i.e., realizes using data and/or by execution of software instructions, a persisted information base (PIB) 140, an agent 150 (a first agent), and a second agent 160. In the example shown, the PIB 140 includes a FIB 142 and an LFIB 144. The FIB 142 defines forwarding instructions for packets based on destination IP (Internet Protocol) addresses, and the LFIB 144 defines forwarding instructions for packets based on labels. The FIB 142 may itself include some label information, e.g., for specifying next hops from IP-based destinations to label-based destinations. One should appreciate, though, that other examples of the PIB 140 may include only the FIB 142 or only the LFIB 144. Also, the PIB 140 may include information bases besides those shown or in addition to those shown, provided that such information bases associate identifiable ingress match criteria with forwarding information. Examples of other information bases include those that specify switching via ethernet frames, tunneling protocols such as GRE (Generic Routing Encapsulation), and VxLAN (Virtual eXtensible Local-Area Network).

The agents 150 and 160 may be arranged in a first tier (agent 150) and a second tier (agent 160). In an example, the agent 150 is a platform-independent agent designed to work with a variety of different ASICs and the agent 160 is a platform-dependent agent designed to work specifically with the ASIC 190. The agent 150 includes a dataset 152, which provides the agent's view of routing information and FEC information. The dataset 152 may be implemented as a table or group of tables, which may be implemented with any suitable data structure, such as one or more arrays, key-value stores, and/or the like. The routing information is stored persistently, but the FEC information is stored in volatile memory and does not survive restarts of the agent 150. The second agent 160 includes a mapping 162, which provides the second agent's view of routing information and FEC information. In an example, the agents 150 and 160 run in separate software processes and cannot communicate using function calls or other synchronous forms of communication. Instead, the agents 150 and 160 may communicate asynchronously, e.g., by one agent posting a table to a shared memory space and the other agent retrieving the table from the shared memory space.

In an example, the second agent 160 relies on the dataset 152 being accurate to avoid errors in forwarding packets and to avoid having to reconfigure its mapping 162. Thus, proper operation of the agent 160 and of the network device 100 as a whole relies on restoring the dataset 152 to its pre-restart settings following a restart of the agent 150.

To this end, the memory 130 further includes a pre-restart persisted table 170 and a FEC relation store 180, both of which are persisted to survive restarts. The pre-restart persisted table 170 associates FEC identifiers 172 used by the agent 150 prior to a restart with fingerprints 174 of FEC values. The FEC identifiers 172 are designated as “AFEC” identifiers, to indicate that the FEC identifiers are those used by the Agent 150 and typically are different from the FEC identifiers used by the PIB 140. The fingerprints 174 are preferably hash values, although other discriminating digests may be used, such as sampled characters of FEC values. In an example, the fingerprints 174 are calculated using a hash function that provides few if any hash collisions across the total number of FEC values, which can number in the millions. To reduce collisions to acceptable limits, a quality hash algorithm should be used which produces fingerprints 174 of at least 64 bits in length. Practical considerations such as available persistent memory may limit implementations to smaller fingerprints (e.g., 32 bits), however, and smaller fingerprints are expected to produce multiple collisions across the millions of FEC values.

The FEC relation store 180 stores parent-child relationships 182 (described below) among FEC identifiers and provides a way of resolving most duplicate fingerprints, which can arise based on hash collisions as well as instances in which multiple FEC identifiers are properly assigned to the same FEC value. The parent-child relationships 182 enable a pre-restart topology (forest) of FECs to be constructed after a restart. The specific manner in which the FEC relation store 180 helps to resolve duplicates will be described further below.

One should appreciate that the FEC relation store 180 may be provided separately from the pre-restart persisted table 170 or may be provided as part of the pre-restart persisted table 170. For example, the pre-restart persisted table 170 may include, in addition to fields for AFEC identifier 172 and fingerprint 174, an additional field for child AFEC identifiers.

In example operation, the network device 100 performs real-time packet forwarding based on routing information and FEC information stored in the PIB 140 and encoded in the ASIC 190. As the network device 100 operates, the agent 150 maintains the routing information and the FEC information in the dataset 152 and keeps current the pre-restart persisted table 170 and FEC relation store 180. When a restart of the agent 150 subsequently occurs, the agent 150 starts up and begins rebuilding its dataset 152. Such rebuilding includes restoring the AFEC identifiers 172 that were used by the agent 150 prior to the restart and associating those AFEC identifiers 172 with FEC values.

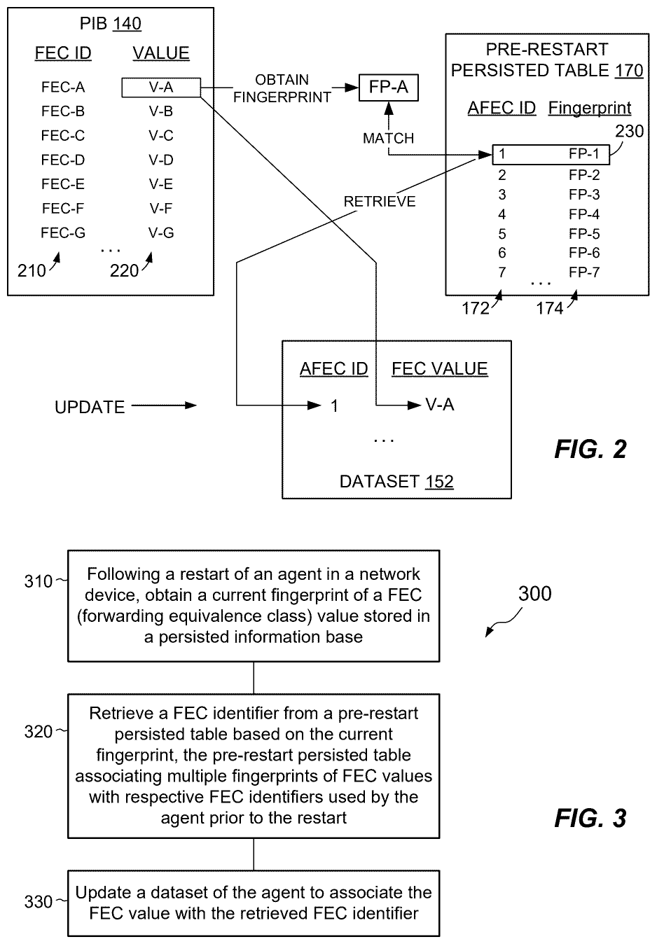

FIGS. 2 and 3 show in greater detail an example rebuilding arrangement (FIG. 2) and associated method (FIG. 3) of recovering FEC information, according to one or more embodiments. In FIG. 2, the PIB 140 persistently stores data that associates FEC identifiers 210 (e.g., FEC-A through FEC-G) with FEC values 220 (e.g., V-A through V-G). The agent 150 may thus rebuild FEC information in the dataset 152 by pairing, based on fingerprint matching, AFEC identifiers 172 in the pre-restart persisted table 170 with FEC values 220 in the PIB 140, and by storing the paired elements in the dataset 152.

For example, at 310 of FIG. 3 the agent 150 obtains a current fingerprint FP-A of a FEC value V-A stored in the PIB 140. The agent 150 may calculate the fingerprint FP-A from V-A at this time, or the agent 150 may obtain FP-A from persistent memory, e.g., if FP-A was calculated previously. At 320, the agent 150 retrieves an AFEC identifier 172 from the pre-restart persisted table 170 based on the current fingerprint, FP-A. For example, the agent 150 performs a lookup in the pre-restart persisted table 170 to identify an entry that associates an AFEC ID 172 with FP-A. The agent 150 identifies entry 230, based on a fingerprint match between FP-A and FP-1, and retrieves the associated AFEC identifier, AFEC 1. At 330, the agent 150 updates the dataset 152 to associate the FEC value V-A with the retrieved AFEC identifier, AFEC 1. Operation may repeat in this manner for a plurality of FEC values 220, such as all of them, until the dataset 152 is completely recovered.

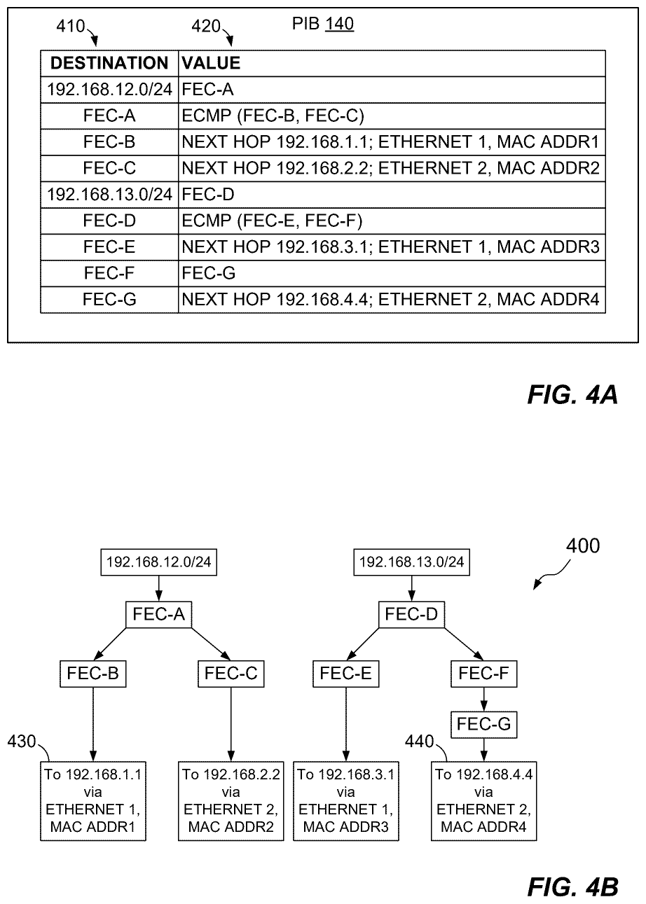

The example of FIGS. 2 and 3 do not address the possibility of duplicates. Example approaches for resolving duplicates as well as additional aspects of the structures presented above will now be described with reference to FIGS. 4A through 11B, in accordance with one or more embodiments.

FIGS. 4A and 4B show example contents of the PIB 140 (FIG. 4A) and an example forest 400 (FIG. 4B), which represents the same contents in graphical form. Although FIGS. 4A and 4B show only nine entries, typical PIBs can include large numbers of entries, such as millions. Further, it is not necessary that the information shown in the PIB 140 be found in any single table. Rather, the information shown in the PIB 140 may be obtained from multiple tables, such as both the FIB 142 and the LFIB 144.

In FIG. 4A, the PIB 140 associates destinations 410 with values 420, such as rules for next hops. In general, destinations 410 expressed as IP-address prefixes are final destinations of packets and are derived from the FIB 142, whereas destinations expressed as FEC identifiers 210 may be derived from any entry in the PIB 140. Values 420 for certain FECs (FEC-A and FEC-D) specify multiple FECs as next hops using ECMP (equal cost multi-pathing).

From FIG. 4B, it is apparent that incoming packets 112 are forwarded to their final destinations (shown at the top) through one or more levels of FECs to reach egress ports (shown at the bottom), from which the packets are forwarded to can reach their final destinations. For example, a packet 112 directed to 192.168.12.0/24 as its final destination first passes to FEC-A. From FEC-A, the packet passes to either FEC-B or FEC-C, e.g., depending on loading. If the packet passes to FEC-B, the packet next exits the network device 100 via port 430, which forwards the packet to its next hop, IP address 192.168.1.1. From there, the packet is eventually forwarded to its final destination, 192.168.12.0/24. The indicator “/24” means that the first 24 bits identify the destination network while the remaining bits identify individual devices on the destination network.

Some paths through the forest 400 may include additional levels of FECs. For example, a packet directed to address 192.168.13.0/24 passes first to FEC-D, and then to FEC-F (assuming FEC-E is not selected), and then to FEC-G before reaching egress port 440.

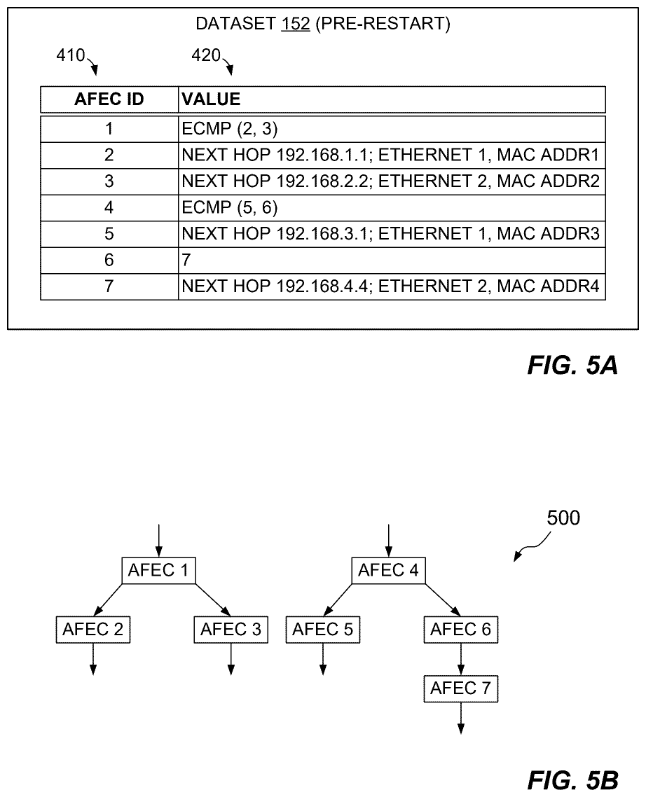

FIGS. 5A and 5B show example contents of the dataset 152 and an equivalent forest 500 prior to restart of the agent 150. The illustrated forest 500 may be referred to herein as a “pre-restart forest” 500. For simplicity, routing information is omitted from FIGS. 5A and 5B and only FEC information is shown. As illustrated, the dataset 152 associates destinations (AFEC identifiers) with respective values (next hops) and thus corresponds directly to the FEC information shown in the PIB 140 (FIG. 4A). However, unlike the PIB 140, the dataset 152 uses different FEC identifiers (AFEC identifiers), which reflect the local FEC identifiers used by the agent 150. The pre-restart forest 500 has the same FEC topology as the PIB forest 400, except that the FEC identifiers in pre-restart forest 500 are the AFEC identifiers used by the agent.

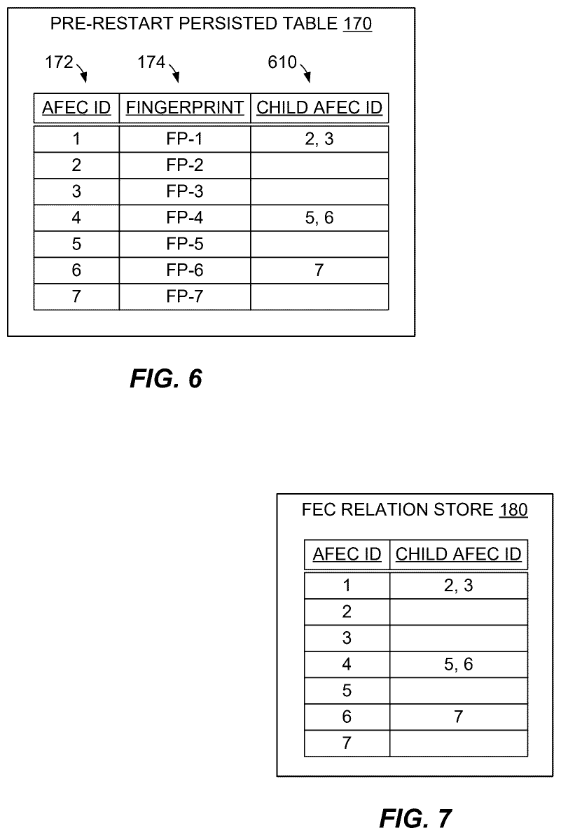

FIG. 6 shows an example arrangement of the pre-restart persisted table 170 according to one or more embodiments, and as applied to the same example of FIGS. 4A-5B. Here, the pre-restart persisted table 170 lists AFEC identifiers 1 through 7, along with associated fingerprints FP-1 through FP-7. In this example, an additional field 610 is provided for the contents of the FEC relation store 180, which is also shown as a separate structure in FIG. 7. One should appreciate that the FEC relation store 180 enables one to recreate the topology of the pre-restart forest 500 (FIG. 5B) after a restart occurs.

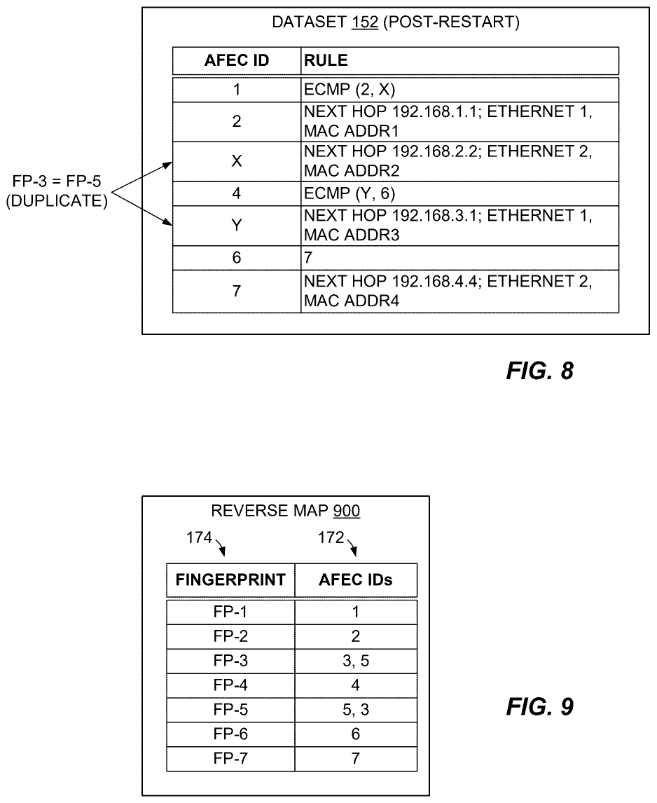

FIG. 8 shows an example of the dataset 152 of FIG. 5A after a restart of the agent 150 and during a recovery process, according to one or more embodiments. Here, the fingerprint-based updates to the dataset 152 (FIGS. 2 and 3) have already been applied, with the following results:
AFEC 1 has been assigned to FEC value V-A (FIG. 2), i.e., “ECMP (2, X)”;
AFEC 2 has been assigned to V-B, i.e., “NEXT HOP 192.168.1.1; ETHERNET 1, MAC ADDR1”;
AFEC 4 has been assigned to V-D, i.e., “ECMP (Y, 6)”;
AFEC 6 has been assigned to V-F, i.e., “7”; and
AFEC 7 has been assigned to V-G, i.e., “NEXT HOP 192.168.4.4; ETHERNET 2, MAC ADDR4”.

AFEC identifiers have not been assigned to V-C or V-E, however, on account of there being a duplicate in the pre-restart persisted table 170 between FP-3 and FP-5. The duplicate means that it cannot immediately be known whether FEC value V-C corresponds to AFEC 3 or to AFEC 5, and likewise whether FEC value V-E corresponds to AFEC 3 or to AFEC 5. The agent 150 temporarily assigns AFEC identifiers X and Y to these unmatched FEC values, as shown.

As a convenience, the agent 150 may build a reverse map 900 (FIG. 9) from the pre-restart persisted table 170 (FIG. 6) to identify hash collisions. The reverse map 900 associates fingerprints 174 with respective AFEC identifiers 172. Duplicates can be readily identified as any fingerprint 174 that the reverse map 900 associates with more than one AFEC identifier 172.

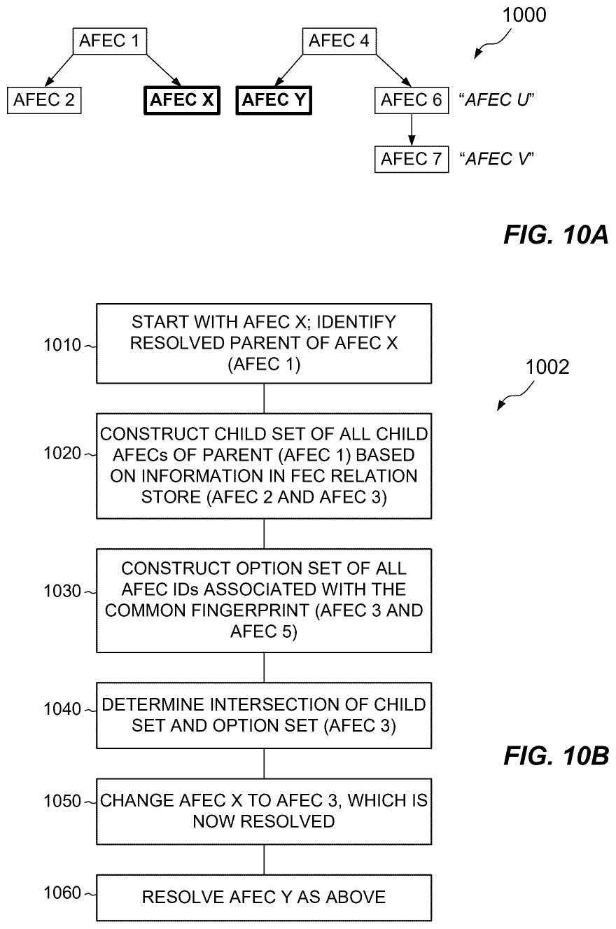

FIGS. 10A and 10B show an example post-restart forest 1000 (FIG. 10A) and a corresponding method 1002 (FIG. 10B) for resolving the above-described duplicate between FP-3 and FP-5, according to one or more embodiments. The method 1002 may be generalized for resolving many duplicates, however. In an example, method 1002 is performed by the agent 150, although certain acts of method 1002 may alternatively be performed by other software constructs running in the network device 100.

In the post-restart forest 1000 (FIG. 10A), temporary AFEC identifiers X and Y are shown in thickened lines. In an example, the post-restart forest 1000 is constructed from FEC values 220 in the PIB 140, which survived the restart, and by applying the fingerprint-matched AFEC identifiers 172 to the FEC values 220.

At 1010 of FIG. 10B, method 1002 starts by attempting to resolve AFEC X and proceeds to identify the resolved parent of AFEC X, which is seen from FIG. 10A to be AFEC 1. A “parent” of a particular FEC is another FEC that points to that particular FEC as a “child.” Here, AFEC 1 is the parent of AFEC X because AFEC 1 points to AFEC X as a child. It is noted that AFEC 1 also has a second child, AFEC 2. It is further noted that top-level FECs, such as AFEC 1 and AFEC 4, are always resolved as they are pointed to by IP routing information, which is persisted. A FEC is “resolved” when its AFEC identifier is known.

At 1020, the agent 150 constructs a child set of all child AFECs of the resolved parent (AFEC 1). In an example, the agent 150 obtains the child set for AFEC 1 from the FEC relation store 180 (FIG. 7), which lists AFECs 2 and 3 as the “children” of AFEC 1.

At 1030, the agent 150 constructs an option set of all AFEC identifiers associated with the common (duplicate) fingerprint, which in this case is FP-3 (or equivalently, FP-5, which equals FP-3). The AFEC identifiers sharing the common fingerprint (FP-3) can be read directly from the reverse map 900 (FIG. 9), which provides the option set for FP-3 as AFECs 3 and 5.

At 1040, the agent 150 determines the intersection of the child set (AFECs 2 and 3) and the option set (AFECs 3 and 5). The intersection of the two sets provides a single result, AFEC 3.

At 1050, the agent 150 changes AFEC X to AFEC 3, and AFEC 3 is now resolved. The same acts may be repeated for resolving AFEC Y (at 1060). For example, the resolved parent of AFEC Y is AFEC 4, and the child set of AFEC 4 is AFECs 5 and 6 (from the FEC relation store 180). The option set from the reverse map 900 is again AFECs 3 and 5, and the intersection of the two sets is AFEC 5. The agent then changes AFEC Y to AFEC 5, which is now resolved.

Resolving AFECs is slightly more complex when hierarchical FECs (HFECs) are involved. For example, if one were to assume that AFEC 6 and AFEC 7 were both unresolved as a result of duplicates and were given temporary identifiers U and V, respectively, then it would be necessary to resolve AFEC U before resolving AFEC V. For example, if the agent 150 attempted to resolve AFEC V first, then no resolved parent of AFEC V could be identified and recovery could not succeed. But resolving AFEC U to AFEC 6 based on resolved parent AFEC 4 does succeed, allowing AFEC V to be resolved successfully based on its newly resolved parent, AFEC 6. Given the presence of HFECs in the post restart forest 1000, it may be desirable to run AFEC recovery in multiple passes, as an AFEC that fails to resolve during a first pass may successfully resolve during a second pass.

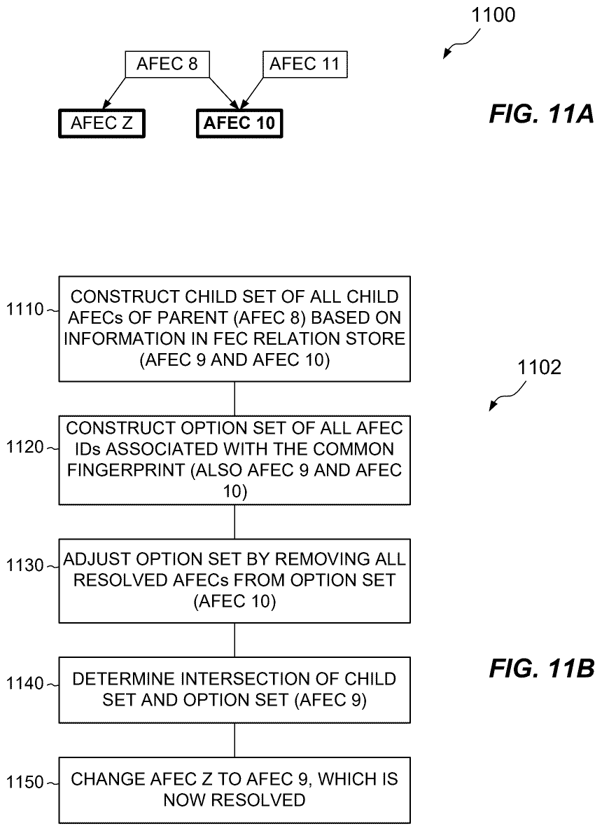

FIGS. 11A and 11B show another post-restart forest 1100 (FIG. 11A) and a corresponding method 1102 (FIG. 11B) for resolving hash collisions based on another fingerprint, according to one or more embodiments. In this case, a duplicate affects AFEC 10 and another AFEC, which has been assigned a temporary identifier Z. Both AFECs 10 and Z share the same parent, AFEC 8.

At 1110 of method 1102, the agent 150 identifies AFEC 8 as a resolved parent of AFEC Z and constructs a child set based on information in the FEC relation store 180, which is now assumed to identify AFECs 9 and 10 as the children of AFEC 8.

At 1120, the agent 150 constructs an option set of all AFEC identifiers associated with the common fingerprint (assumed to be known), e.g., by accessing the reverse map 900. It is further assumed that the reverse map 900 identifies the option set as AFECs 9 and 10, i.e., the same AFECs as were found in the child set. As the intersection of the two sets produces two results (AFECs 9 and 10), operation proceeds to 1130, whereupon the option set is adjusted by removing therefrom all AFECs that have already been resolved. In this example, AFEC 10 has been resolved, leaving only AFEC 9 in the option set.

At 1140, the agent 150 determines the intersection of the child set (AFECs 9 and 10) with the option set (AFEC 9), producing a single result, AFEC 9. At 1150, the agent 150 changes AFEC Z to AFEC 9, which is now resolved.

It is noted that removing resolved AFECs from the option set is always a valid approach, even in the example of FIGS. 10A and 10B, as resolved AFECs are never candidates for unresolved AFECs.

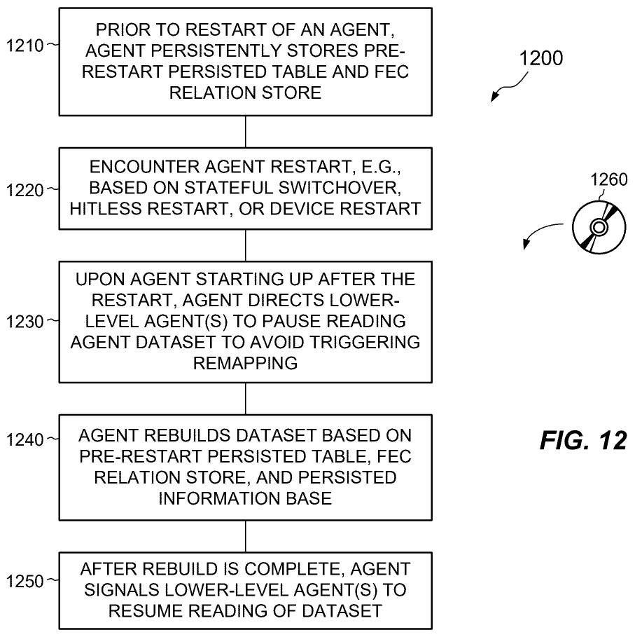

FIG. 12 shows an example method 1200 that may be carried out in connection with the network device 100. The method 1200 is typically performed, for example, by the agent 150 and/or other software constructs described in connection with FIG. 1, which reside in the memory 130 of the network device 100 and are run by one or more of processors 120. The various acts of method 1200 may be ordered in any suitable way. Accordingly, embodiments may be constructed in which acts are performed in orders different from that illustrated, which may include performing some acts simultaneously.

At 1210, the agent 150 persistently stores a pre-restart persisted table 170 and a FEC relation store 180. The agent 150 preferably keeps these structures current with any changes made in the PIB 140, e.g., in the FIB 142 and/or the LFIB 144.

At 1220, the agent 150 encounters a restart. For example, the restart may be based on a stateful switchover (SSO) between the processor 120a and the processor 120b, which occurs with little or no disruption to packet forwarding by the network device 100. Alternatively, the restart may be part of a hitless restart, i.e., a restart of the agent 150 but not of the network device 100 as a whole. The hitless restart is also nondisruptive or minimally disruptive to packet forwarding. As yet another example, the agent restart may be part of a total restart of the entire network device 100.

At 1230, upon the agent starting up after the restart, the agent 150 directs the second agent 160 to pause reading of the dataset 152 until the agent 150 has rebuilt the dataset 152. Such pausing avoids routing errors and remapping by the second agent 160.

At 1240, the agent 150 rebuilds its dataset 152 in the manner described above, based on information stored in the pre-restart persisted table 170, the FEC relation store 180, and the PIB 140.

At 1250, Once the agent 150 has finished rebuilding the dataset 152, the agent 150 may signal the second agent 160 to resume reading the dataset 152, as such reading can now be done without adverse downstream effects.

In some examples, the method 1200 may be embodied as a computer program product that includes one or more non-transient, computer-readable storage media 1260, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like. Any number of computer-readable media may be used. The media may be encoded with instructions which, when executed on one or more processors, perform the process or processes described herein. Such media may be considered articles of manufacture or machines, and may be transportable from one machine to another.

An improved technique has been described for restoring data in a network device 100. In accordance with the improved technique, an agent 150 runs in the network device 100 and, prior to a restart of the agent 150, persistently stores a table 170 of FEC identifiers 172 used by the agent 150 and fingerprints 174 of associated FEC values 420. After the restart, the agent 150 starts up and begins rebuilding the FEC information in its dataset 152. To this end, the agent 150 obtains FEC values 220 from a persisted information base (PIB) 140, such as a FIB and/or LFIB, which persisted through the restart. The agent assigns FEC identifiers 172 from the persisted table 170 to the FEC values 220 obtained from the PIB 140 by matching fingerprints calculated from the FEC values 420 with fingerprints 174 stored in the table 170. The agent 150 then updates its dataset 152 with the assigned FEC identifiers 172 and the obtained FEC values 220. Advantageously, the improved technique enables recovery of the agent's dataset 152 without having to communicate with other software components running in other processes. It also conserves persistent memory space by storing fingerprints of FEC values instead of the potentially voluminous FEC values themselves.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of restoring data in a network device, comprising:
after a restart of an agent in the network device, obtaining, by the agent, a current fingerprint of a FEC (forwarding equivalence class) value stored in a persisted information base;
retrieving, by the agent, a FEC identifier from a pre-restart persisted table based on the current fingerprint, the pre-restart persisted table associating multiple fingerprints of FEC values with respective FEC identifiers used by the agent prior to the restart; and
updating a dataset of the agent to associate the retrieved FEC identifier with the FEC value.

2. The method of claim 1, wherein the persisted information base includes at least one of a FIB (forwarding information base) and an LFIB (label forwarding information base).

3. The method of claim 1, wherein the persisted information base stores a plurality of FEC values, and wherein the method further comprises performing the acts of obtaining, retrieving, and updating to associate a plurality of retrieved FEC identifiers with the plurality of FEC values.

4. The method of claim 3, wherein the agent is a first agent and the method further comprises:
reading the updated dataset by a second agent in the network device, the second agent configured to maintain a mapping of FEC identifiers to FEC values and to rebuild the mapping responsive to changes in FEC identifiers in the dataset,
wherein the updated dataset includes a plurality of FEC identifiers used by the agent prior to the restart and restored after the restart, such that the second agent avoids rebuilding the mapping for the plurality of FEC identifiers after the restart.

5. The method of claim 4, further comprising directing the second agent to pause reading of the dataset while the first agent restores the plurality of FEC identifiers.

6. The method of claim 3, further comprising storing, by the agent prior to the restart, a FEC relation store, the FEC relation store storing parent-child relationships that associate FEC identifiers of multiple parent FECs with respective sets of child FEC identifiers of child FECs of the parent FECs.

7. The method of claim 6, further comprising resolving duplicate fingerprints stored in the pre-restart persisted table based on the parent-child relationships stored in the FEC relation store.

8. The method of claim 6, wherein the fingerprints in the pre-restart persisted table include a first fingerprint calculated from a FEC value of a first FEC, the first fingerprint being associated with multiple FEC identifiers in the pre-restart persisted table, and wherein the method further comprises:
identifying a parent FEC of the first FEC, the parent FEC having a recovered FEC identifier;
retrieving, from the FEC relation store, a set of child FEC identifiers of the parent FEC;
forming an option set that contains all FEC identifiers associated with the first fingerprint in the pre-restart persisted table;
identifying a common FEC identifier common to both the set of child FEC identifiers and the option set; and
assigning the common FEC identifier to the first FEC.

9. The method of claim 8, further comprising, prior to assigning the common FEC identifier to the first FEC, assigning a temporary FEC identifier to the first FEC.

10. The method of claim 8, wherein the fingerprints in the pre-restart persisted table further include a second fingerprint calculated from a FEC value of a second FEC, the second fingerprint being associated with multiple FEC identifiers in the pre-restart persisted table, wherein the second FEC is a child of the first FEC, and wherein the method further comprises determining a FEC identifier of the second FEC after assigning the common FEC identifier to the first FEC.

11. The method of claim 6, wherein the fingerprints in the pre-restart persisted table include a first fingerprint calculated from a FEC value of a first FEC, wherein the pre-restart persisted table associates multiple FEC identifiers with the first fingerprint, and wherein the method further comprises:
forming an option set by providing the FEC identifiers associated with the first fingerprint and removing recovered FEC identifiers from the FEC identifiers associated with the first fingerprint;
identifying a parent FEC of the first FEC, the parent FEC having a recovered FEC identifier;
retrieving a set of child FEC identifiers of the parent FEC from the FEC relation store;
identifying a common FEC identifier found in both the set of child FEC identifiers and the option set; and
assigning the common FEC identifier to the first FEC.

12. The method of claim 1, wherein the restart of the agent is performed without restarting the network device.

13. The method of claim 1, wherein the restart of the agent is performed as part of restarting the network device.

14. A network device, comprising control circuitry that includes a set of processors coupled to memory, the control circuitry constructed and arranged to:
operate an agent;
prior to a restart of the agent, persistently store a pre-restart persisted table that associates multiple fingerprints of FEC (forwarding equivalence class) values with respective FEC identifiers used by the agent;
after the restart of the agent, obtain current fingerprints of a plurality of FEC values stored in a persisted information base, retrieve a plurality of FEC identifiers from the pre-restart persisted table based on the current fingerprints, and update a dataset of the agent to associate the plurality of FEC values with the plurality of FEC identifiers.

15. The network device of claim 13, wherein the set of processors includes a first processor and a second processor, wherein the control circuitry is constructed and arranged to control the network device using the first processor but not the second processor prior to the restart, and wherein the control circuitry is constructed and arranged to control the network device using the second processor but not the first processor after the restart.

16. The network device of claim 14, wherein the control circuitry is further constructed and arranged to restart the agent independently of other agents running on the network device.

17. The network device of claim 14, wherein the control circuitry is further constructed and arranged to:
prior to the restart of the agent, persistently store a FEC relation store, the FEC relation store storing parent-child relationships that associate FEC identifiers of multiple parent FECs with respective sets of child FEC identifiers of child FECs of the parent FECs; and
after the restart of the agent, resolving duplicate fingerprints stored in the pre-restart persisted table based on the parent-child relationships stored in the FEC relation store.

18. A computer program product including a set of non-transitory, computer-readable media having instructions which, when executed by control circuitry of a computerized apparatus, cause the computerized apparatus to perform a method of restoring data in a network device, the method comprising:
operating an agent in the network device;
prior to a restart of the agent, persistently storing a pre-restart persisted table that associates multiple fingerprints of FEC (forwarding equivalence class) values with respective FEC identifiers used by the agent;
after the restart of the agent, obtaining current fingerprints of a plurality of FEC values stored in a persisted information base, retrieving a plurality of FEC identifiers from the pre-restart persisted table based on the current fingerprints, and updating a dataset of the agent to associate the plurality of FEC values with the plurality of FEC identifiers.

19. The computer program product of claim 18, wherein the method further comprises, prior to the restart of the agent, storing a FEC relation store, the FEC relation store storing parent-child relationships that associate FEC identifiers of multiple parent FECs with respective sets of child FEC identifiers of child FECs of the parent FECs.

20. The computer program product of claim 19, wherein the method further comprises, after the restart of the agent, resolving duplicate fingerprints stored in the pre-restart persisted table based on the parent-child relationships stored in the FEC relation store.
